(19) United States
(12) Patent Application Publication
(10) Pub. No.: US 2007/0165368 A1
(43) Pub. Date: Jul. 19, 2007

(54) Key operated apparatus having shield and method of making the same

(75) Inventors: Chien-Shih Hsu, Longtan Shiang (TW); Chih-Hsiang Chiang, Zhongli City (TW)

Correspondence Address: ATTN: Juan Carlos A. Marquez;REED SMITH LLP, Suite 1400, 3110 Fairview Park Drive, Falls Church, VA, 22042, US

(73) Assignee: Darfon Electronics Corporation

(21) Appl. No.: 11/653,871

(22) Filed: Jan. 17, 2007

(30) Foreign Application Priority Data
Jan. 18, 2006 (TW) 95101925

(51) Int. Cl. G06F 1/16

(52) U.S. Cl. 361/680

(57) ABSTRACT

A key operated apparatus with a shield and a method of making the same are provided. The shield is used to block any undesired matters, such as water or dust, from entering an internal space formed by the shield and a bottom plate of the key operated apparatus. A plurality of keycaps positioned outside of the internal space are fixed on the shield and supported by a plurality of holders within the internal space, wherein the shield is elastically deformable when any one of the keycaps moves up and down.

### RELATED APPLICATION

This application claims the right of priority based on Taiwan Patent Application No. 095101925 entitled “Key Operated Apparatus Having Shield and Method of making the Same”, filed on Jan. 18, 2006, which is incorporated herein by reference and assigned to the assignee herein.

### TECHNICAL FIELD

The present invention relates to a key operated apparatus, and more particularly to a key operated apparatus having a shield.

### BACKGROUND OF THE INVENTION

Typical key operated apparatus of the electronic devices, such as keyboards for computers, keys on remote controllers or mobile phones, or buttons on any instruments, are usually failed by the invasion of dust or water. The invasion of dust or water causing the failures of circuits inside the key operated apparatus is usually through gaps between keys.

To solve this problem, a key protector is provided to cover the entire key operated apparatus when it is not in use. However, when the key operated apparatus is to be used, the key protector has to be removed. Accordingly, the key operated apparatus still lacks of protection during operation.

Therefore, a key operated apparatus being dust and waterproof during operation is needed.

### SUMMARY OF THE INVENTION

One aspect of the invention is to provide a key operated apparatus having a shield, and the shield includes at least one portion, which is elastically deformable as one of a plurality of keycaps moving up and down.

In one embodiment, the present invention provides a key operated apparatus including a bottom plate; a keycap having a connecting portion; a shield having an opening, the shield being flexible and placed between the keycap and the bottom plate, the connecting portion passing the shield through the opening; and a holder having an upper end and a lower end, wherein the upper end is coupled to the connecting portion, and the lower end is coupled to the bottom plate so that the keycap is capable of moving up and down relative to the bottom plate. It should be noticed that the term “movably” is referred to as rotatably, removably, or the combination thereof.

In another embodiment, the present invention provides a keyboard including a bottom plate, a plurality of keycaps, a shield being flexible, and a plurality of sleeves. Each keycap has a plunger. The shield having a plurality of openings is placed between the plurality of keycaps and the bottom plate, and the plungers pass the shield through the plurality of openings. The plurality of sleeves is placed on the bottom plate. The plungers socket into the plurality of sleeves to make the plurality of keycaps capable of moving up and down relative to the bottom plate.

Another aspect of the invention is to provide a method of making a keyboard having a shield.

In one embodiment, the present invention provides a method including the steps of providing a flexible shield having a plurality of openings; providing a plurality of keycaps, each keycap having a connecting portion; fixing the plurality of keycaps on the shield, and making the connecting portions pass the shield through the plurality of openings.

In another embodiment, the present invention provides a method including the steps of providing a flexible shield having a plurality of openings; providing a plurality of keycaps, each keycap having a plunger; fixing the plurality of keycaps on the shield, and making the plungers pass the shield through the plurality of openings; providing a bottom plate having a plurality of sleeves; and mounting the shield on the bottom plate, and making the plungers socket into the plurality of sleeves.

### BRIEF DESCRIPTION OF THE DRAWINGS

FIGS. 1A-1B are exploded diagrams depicting the key operated apparatus in accordance with a first embodiment of the present invention, wherein FIG. 1A is a front perspective diagram of the elements, and FIG. 1B is a back perspective diagram of the same.

FIG. 1C is a cross-sectional diagram depicting the key operated apparatus of the first embodiment.

FIG. 2A is an exploded diagram depicting the key operated apparatus in accordance with a second embodiment of the present invention.

FIG. 2B is a cross-sectional diagram depicting the key operated apparatus of the second embodiment.

FIG. 3 is a manufacturing flowchart for the first embodiment of the present invention.

FIG. 4 is a manufacturing flowchart for the second embodiment of the present invention.

### DETAILED DESCRIPTION OF THE PREFERRED EMBODIMENT

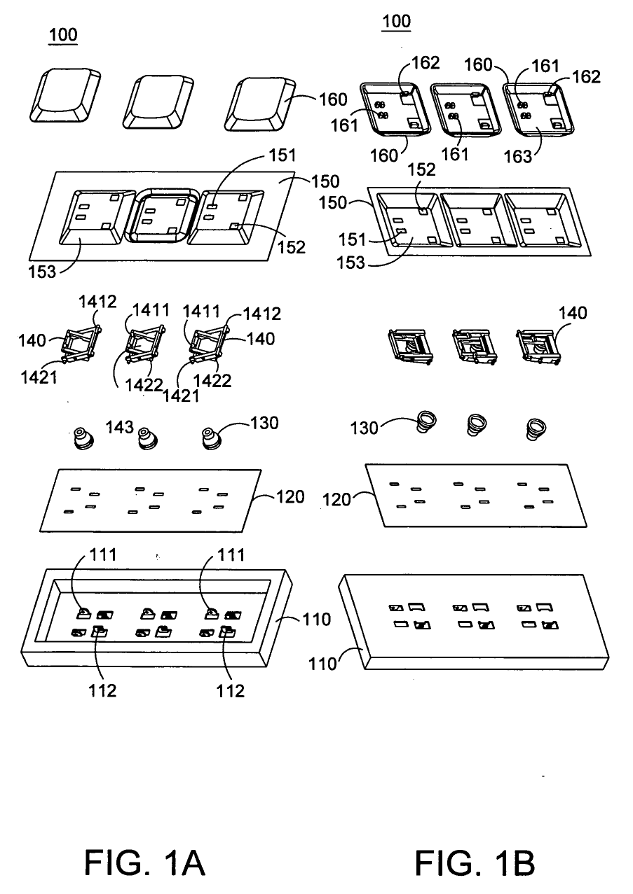

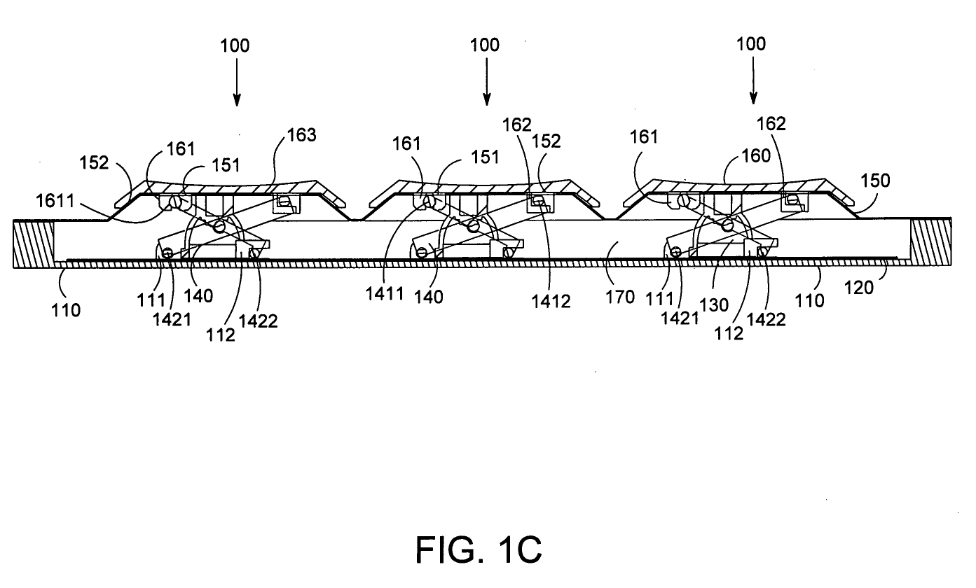

FIGS. 1A-1C illustrate a first embodiment of the present invention.

FIGS. 1A-1B show the exploded diagrams of a key operated apparatus 100 having a plurality of keys, wherein FIG. 1A is a front perspective diagram depicting the elements of the key operated apparatus 100, and FIG. 1B is a back perspective diagram of the same. As shown in the diagrams, the key operated apparatus 100 includes a bottom plate 110, a circuit layer 120, an elastic body 130, a scissors-like holder 140, a shield 150, and a key cap 160. The bottom plate 110 includes a first fixing member 111 and a second fixing member 112. The inner surface 163 of the keycap 160 has a first connecting portion 161 and a second connecting portion 162. The shield 150 has a first opening 151, a second opening 152, and a projecting structure 153. In other words, the shield 150 is a sheet formed with the projecting portion 153, and the openings 162, 162 are formed in the projecting portion 153. The first opening 151 and the second opening 152 are respectively for the first connecting portion 161 and the second connecting portion 162 to pass through the shield 150. To avoid undesired large gaps between the shield 150 and the connecting portions 161 and 162, the shapes of the openings 151 and 152 are preferably designed to be substantially the same as the profiles of the cross-section of the connecting portions 161 and 162 respectively, so that the openings 151/152 and the connecting portions 161/162 can correspondingly match each other and thereby minimize the undesired gaps. Besides, the shape of the projecting structure 153 may also be substantially the same as the shape of the inner surface 163 of the keycap 160. In addition, the scissors-like holder 140 also includes a first upper end 1411, a second upper end 1412, a first lower end 1421, and a second lower end 1422. The detailed descriptions for these elements are provided as below.

FIG. 1C is a cross-sectional diagram depicting the key operated apparatus 100 formed by assembling the elements described above. As shown in FIG. 1C, the shield 150 is placed between the keycap 160 and the bottom plate 110. Note that there is an internal space 170 formed by the shield 150 and the bottom plate 110, and the shield 150 is for blocking impurities, dust, or water from entering the internal space 170.

Further referring to FIG. 1C, the connecting portions 161 and 162 passing the shield 150 respectively through the openings 151 and 152 are movably coupled to the first upper end 1411 and the second upper end 1412 respectively. More specifically, the first upper end 1411 is rotatably coupled to the first connecting portion 161 while the second upper end 1412 is removably coupled to the second connecting portion 162. Similarly, the first lower end 1421 is rotatably coupled to the first fixing member 111 while the second lower end 1422 is removably coupled to the second fixing member 112. Therefore, the first lower end 1421 and the second lower end 1422 of the scissors-like holder 140 are respectively rotatably and removably coupled to the first fixing member 111 and the second fixing member 112 of the bottom plate 110.

Still referring to FIG. 1C, the scissors-like holder 140 is utilized to support the keycap 160 so that the keycap 160 can move up and down so as to selectively activate the circuit layer 120. When a user pushes the keycap 160, the elastic body 130 is compressed, and when the user releases the keycap 160, the keycap 160 recovers by the elastic force of the elastic body 130. It should be understood that variations might be made to the scissors-like holder 140. Consequently, the coupling of the scissors-like holder 140 with the keycap 160 and the bottom plate 120 mentioned above is for the purpose of illustration rather than limitation.

Referring to FIG. 1C again, the shield 150 is made of a flexible material, which is elastically deformable along with the keycap 160 moving up and down. A waterproof material such as PU (Poly Urethane) or rubber is preferred. Additionally, please note that according to the embodiment of the present invention, the shape of the projecting structure 153 of the shield 150 is substantially the same as the shape of the inner surface 163 of the keycap 160 so as to allow at least the top portion of the projecting structure 153 to be embedded within the keycap 160 and thereby the keycap 160 is fixed on the shield 150. Fixing the keycap 160 on the shield 150 is advantageous for preventing the shield 150 and the keycap 160 from rubbing each other, which may result in the undesired abrasion or noise when the keycap 160 is moving up and down. Alternatively, the top surface of the projecting structure 153 may be coated with suitable adhesives to intimately bond the keycap 160 and the shield 150. In other words, in accordance with the embodiment of the present invention, the keycap 160 can be fixed on the shield 150 in various ways but not limited to embedding or adhesion as mentioned above.

In addition, please note that the present invention includes the apparatus 100 having only one key or a plurality of keys such as a keyboard. The number of key for the apparatus depends upon the user's need. It is for illustrating purpose to show only three keys in FIGS. 1A-1C.

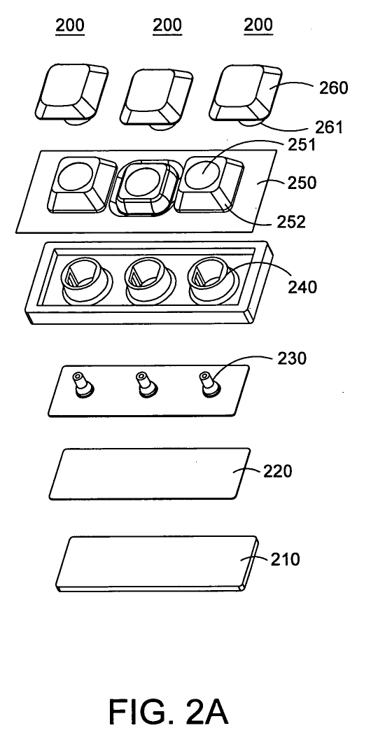

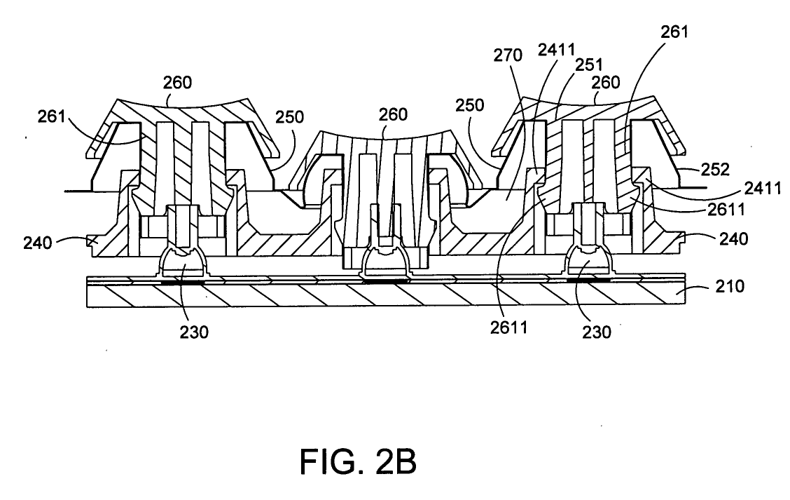

FIGS. 2A-2B illustrate a second embodiment of the present invention.

FIG. 2A shows an exploded diagram depicting a key operated apparatus 200 having a plurality of keys. As shown in FIG. 2A, the key operated apparatus 200 includes a bottom plate 210, a circuit layer 220, an elastic body 230, a sleeve 240, a shield 250, and a key cap 260. The keycap 260 downwardly extends to form the plunger 261. The shield 250 is formed with an opening 251 and a projecting structure 252. The opening 251 is for the plunger 261 to pass through the shield 250. To avoid undesired large gaps between the shield 250 and the plunger 261, the shapes of the opening 251 is preferably substantially the same as the profile of the cross-section of the plunger 261, so that the openings 251 and the plunger 261 can correspondingly match each other and thereby minimize the undesired gap. Preferably, the shape of the projecting structure 252 is substantially the same as the shape of the inner surface of the keycap 260.

FIG. 2B is a cross-sectional diagram depicting the key operated apparatus 200 consisting of the elements described above. As shown in FIG. 2B, the shield 250 is placed between the keycap 260 and the bottom plate 210, such that an internal space 270 is formed between the shield 250 and the bottom plate 210. The shield 250 is for blocking impurities, dust, or water from entering the internal space 270. Furthermore, the plunger 261 passing the shield 250 through the opening 251 sockets into the sleeve 240. Therefore the keycap 260 is capable of moving up and down relative to the bottom plate and selectively touching the underlying circuit layer 220. When a user pushes the keycap 260, the elastic body 230 is compressed, and when the user releases the keycap 260, the keycap 260 recovers by the elastic force of the elastic body 230. To prevent the keycap 260 from getting out of the sleeve 240, the sleeve 240 may include a first protruding portion 2411 to engage with a second protruding portion 2611 of the plunger 261. It should be understood that many variations might be made to the keycap 260 and the sleeve 240 and not limited by which is illustrated by the present invention.

Moreover, as mentioned above, the shield 250 is made of a flexible material, which is elastically deformable along with the keycap 260 moving up and down. A waterproof material such as PU or rubber is preferred. Additionally, please note that according to the embodiment of the present invention, the shape of the projecting structure 252 of the shield 250 is preferably substantially the same as the shape of the inner surface of the keycap 260 so as to allow at least the top portion of the projecting structure 252 to be embedded within the keycap 260 and thereby the keycap 260 is fixed on the shield 250. Fixing the keycap 260 on the shield 250 is advantageous for preventing the shield 250 and the keycap260 from rubbing each other, which may result in the undesired abrasion or noise when the keycap 260 is moving up and down. Alternatively, the top surface of the projecting structure 252 may be coated with suitable adhesives to intimately bond the keycap 260 and the shield 250. In other words, in accordance with the embodiment of the present invention, the keycap 260 can be fixed on the shield 250 in various ways but not limited to embedding or adhesion as mentioned above.

In addition, please note that the present invention includes the apparatus 2100 having only one key or a plurality of keys such as a keyboard. The number of key for the apparatus depends upon the user's need. It is for illustrating purpose to show only three keys in FIGS. 2A-2B.

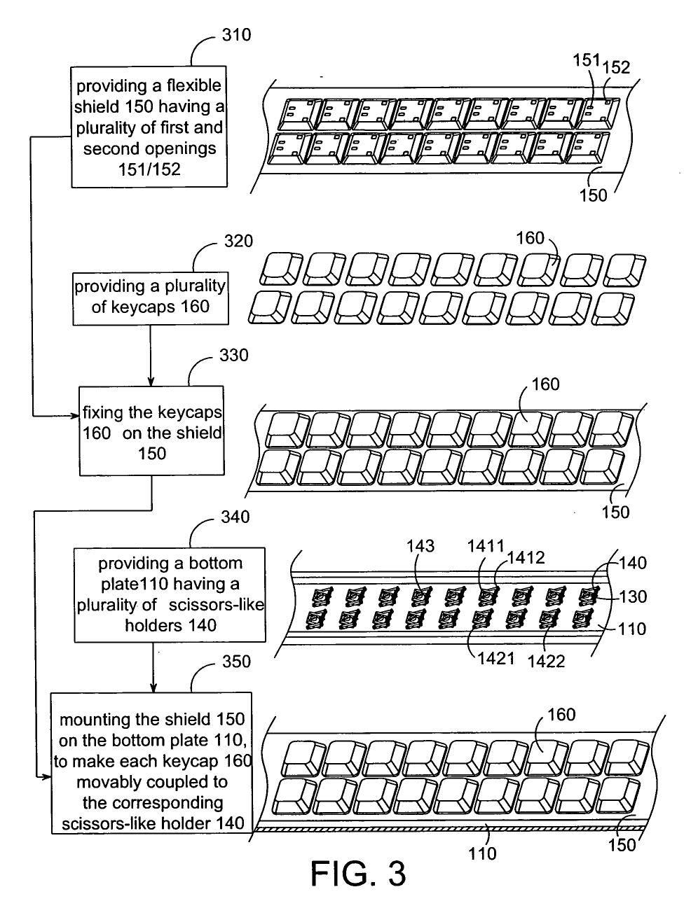

FIG. 3 discloses a method of manufacturing a keyboard having a plurality of keys according to the first embodiment. As shown in FIG. 3, the step 310 is providing a flexible shield 150 having a plurality of first openings 151 and second openings 152. The step 320 is providing a plurality of keycaps 160, in which each of the plurality of keycaps 160 includes the first connecting portion 161 and the second connecting portion 162 (as shown in FIG. 1B). The step 330 is fixing each of the plurality of keycaps 160 on the shield 150, and making the first connecting portion 161 and the second connecting portion 162 pass the shield 150 respectively through the first opening 151 and the second opening 152.

The step 340 is providing a bottom plate 110 having a plurality of scissors-like holders 140, in which each of the plurality of scissors-like holders includes the first upper end 1411, the second upper end 1412, the first lower end 1421, and the second lower end 1422. The lower ends 1421 and 1422 are movably coupled to the first fixing member 111 and the second fixing member 112 of the bottom plate 110 (as shown in FIG. 1C). A plurality of elastic bodies 130 are respectively placed in the opening 143 of each of the plurality of scissors-like holders 140.

The step 350 is mounting the shield 150 on the bottom plate 110, to make each keycap 160 movably coupled to the first upper end 1411 and the second upper end 1412 of the corresponding scissors-like holder 140 through the first connecting portion 161 and the second connecting portion 162. The resultant structure is as shown in FIG. 1C.

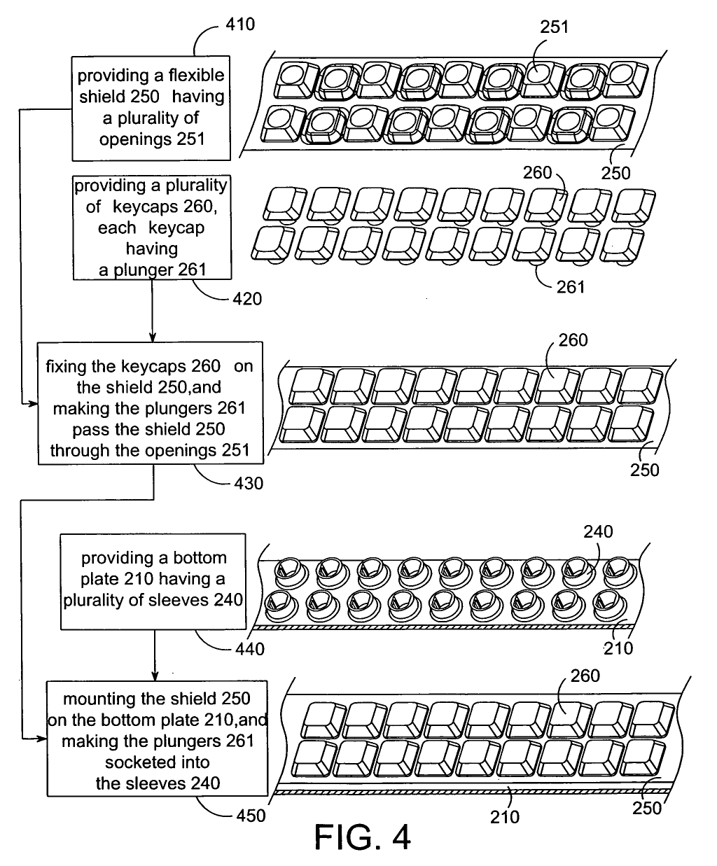

FIG. 4 discloses a method of making a keyboard having a plurality of keys according to the second embodiment. As shown in FIG. 4, the step 410 is providing a flexible shield 250 having a plurality of openings 251. The step 420 is providing a plurality of keycaps 260, in which each of the plurality of keycaps 260 includes a plunger 261. The step 430 is fixing each of the plurality of keycaps 260 on the shield 250 and making the plungers 261 pass the shield 250 through the corresponding openings 251. The step 440 is providing a bottom plate 210 having a plurality of sleeves 240. As described above, the bottom plate 210 may further include a circuit layer 220 and a plurality of elastic bodies 130, which are not shown here for simplicity. The step 450 is mounting the shield 250 on the bottom plate 210, and making the plungers 261 socketed into the sleeves 240.

It should be noticed that the reference numerals 310 to 350 and 410 to 450 are only illustrative and not intended to limit the performing order of the steps of the present invention.

The method of the present invention has other advantages in addition to making the foregoing key operated apparatus and keyboards. For example, according to the method of the present invention, a plurality of keycaps 160/260 are pre-positioned on the shield 150/250. When mounting the shield 150/250 on the bottom plate 110/210, the plurality of keycaps 160/260 are mounted on the holders (namely being movably coupled to the scissors-like holders 140 or socketing into the sleeves 240) at the same time. Additionally, to check or repair the internal structure of assembled keyboard, only removing the shield 150/250 is necessary, but not one by one removing the keycaps.

The detailed description of the above preferable embodiments is to describe the technical features and spirit of the present invention, and the disclosed preferable embodiments are not intended to limit the scope of the present invention. On the contrary, the preferable embodiments and its variations or equivalents all fall within the scope of the present invention. Therefore, the scope of the present invention should be most broadly explained according to the foregoing description and includes all possible variations and equivalents.

We claim:

1. A key operated apparatus, comprising:
a bottom plate;
a keycap having a connecting portion;
a shield having an opening, the shield being flexible and placed between the keycap and the bottom plate, the connecting portion passing the shield through the opening; and
a holder having an upper end and a lower end;
wherein the upper end is coupled to the connecting portion, and the lower end is coupled to the bottom plate so that the keycap is capable of moving up and down relative to the bottom plate.

2. The key operated apparatus according to claim 1, wherein the shield has a projecting structure, and the shape of the projecting structure is substantially the same as the shape of the inner surface of the keycap.

3. The key operated apparatus according to claim 1, wherein the shield is made of a material selected from a group consisting of rubber and PU.

4. The key operated apparatus according to claim 1, wherein the shape of the opening is substantially the same as the profile of the cross-section of the connecting portion.

5. The key operated apparatus according to claim 1, wherein the holder comprises a scissors-like structure.

6. A keyboard, comprising:
a bottom plate;
a plurality of keycaps, each keycap having a connecting portion;
a plurality of holders, each holder having an upper end and a lower end so as to make each keycap capable of moving up and down relative to the bottom plate, the upper end being coupled to the connecting portion, and the lower end being coupled to the bottom plate; and
a shield being flexible and placed between the plurality of keycaps and the bottom plate;
wherein the shield has a plurality of openings, and the connecting portions pass the shield through the plurality of openings.

7. The keyboard according to claim 6, wherein the shield has a projecting structure, and the shape of the projecting structure is substantially the same as the shape of the inner surface of one of the plurality of keycaps.

8. The keyboard according to claim 6, wherein the shield is made of a material selected from a group consisting of rubber and PU.

9. The keyboard according to claim 6, wherein the shape of each opening is substantially the same as the profile of the cross-section of each connecting portion.

10. The keyboard according to claim 6, wherein the holder comprises a scissors-like structure.

11. A key operated apparatus, comprising:
a bottom plate;
a keycap capable of moving up and down relative to the bottom plate; and
a shield being flexible and placed between the keycap and the bottom plate.

12. The key operated apparatus according to claim 11, further comprising a plunger extended from the keycap and a sleeve placed on the bottom plate for making the keycap move up and down relative to the bottom plate.

13. The key operated apparatus according to claim 12, wherein the shield has an opening, and the plunger passing the shield through the opening sockets into the sleeve.

14. The key operated apparatus according to claim 11, wherein the shield has a projecting structure, and the shape of the projecting structure is substantially the same as the shape of the inner surface of the keycap.

15. The key operated apparatus according to claim 11, wherein the shield is made of a material selected from a group consisting of rubber and PU.

16. The key operated apparatus according to claim 13, wherein the shape of the opening is substantially the same as the profile of the cross-section of the plunger.

17. A keyboard, comprising:
a bottom plate;
a plurality of keycaps capable of moving up and down relative to the bottom plate; and
a shield being flexible and placed between the plurality of keycaps and the bottom plate.

18. The keyboard according to claim 17, further comprising a plunger extended from each keycap and a plurality of sleeves on the bottom plate, wherein each plunger sockets into each sleeve.

19. The keyboard according to claim 18, wherein the shield has a plurality of openings, and the plungers pass the shield through the plurality of openings.

20. The keyboard according to claim 17, wherein the shield has a projecting structure, and the shape of the projecting structure is substantially the same as the shape of the inner surface of one of the plurality of keycaps.

21. The keyboard according to claim 17, wherein the shield is made of a material selected from a group consisting of rubber and PU.

22. The keyboard according to claim 19, wherein the shape of each opening is substantially the same as the profile of the cross-section of each plunger.

23. A method of making a keyboard, comprising:
providing a flexible shield having a plurality of openings;
providing a plurality of keycaps, each keycap having a connecting portion;
fixing the plurality of keycaps on the shield, and making the connecting portions pass the shield through the plurality of openings;
providing a bottom plate having a plurality of holders, each holder having an upper end and a lower end, and the lower end being coupled to the bottom plate; and
mounting the shield on the bottom plate to make the plurality of keycaps coupled to the upper ends through the connecting portions.

24. The method according to claim 23, wherein the plurality of keycaps are adhesively fixed on the shield.

25. The method according to claim 23, wherein the shield has a projecting structure, and the shape of the projecting structure is substantially the same as the shape of the inner surface of one of the plurality of keycaps.

26. The method according to claim 23, wherein the shield is made of a material selected from a group consisting of rubber and PU.

27. The method according to claim 23, wherein one of the plurality of holders comprises a scissors-like structure.

28. A method of making a keyboard, comprising:
providing a flexible shield having a plurality of openings;
providing a plurality of keycaps, each keycap having a plunger;
fixing the plurality of keycaps on the shield, and making the plungers pass the shield through the plurality of openings;
providing a bottom plate having a plurality of sleeves; and
mounting the shield on the bottom plate, and making the plungers socket into the plurality of sleeves.

29. The method according to claim 28, wherein the plurality of keycaps are adhesively fixed on the shield.

30. The method according to claim 28, wherein the shield has a projecting structure, and the shape of the projecting structure is substantially the same as the shape of the inner surface of one of the plurality of keycaps.

31. The method according to claim 28, wherein the shield is made of a material selected from a group consisting of rubber and PU.
